(19) United States
(12) Patent Application Publication
(10) Pub. No.: US 2024/0326750 A1
(43) Pub. Date: Oct. 3, 2024

(54) SCHEIBENWISCHERSYSTEM FÜR EIN FAHRZEUG

(71) Applicant: Robert Bosch GmbH, Stuttgart (DE)

(72) Inventor: Helmut Depondt, Boutersem (BE)

(21) Appl. No.: 18/613,649

(22) Filed: Mar. 22, 2024

(30) Foreign Application Priority Data
Mar. 27, 2023 (DE) 10 2023 202 737.2

(51) Int. Cl. B60S 1/52

(52) U.S. Cl. CPC B60S 1/522

(57) ABSTRACT

A windshield wiper system for a vehicle, includes a wiper blade having a spraying device, a fluid line, a wiper arm on which the fluid line is arranged or retained, and a retaining device, The spraying device includes a spraying device connector, the fluid line includes a line coupler, and the fluid line and the spraying device can be connected to each other in a non-destructive and detachable fluidic connection via the line coupler and the spraying device connector. The retaining device is arranged on the wiper blade, the retaining device in a first state is configured to enable non-destructive detachment of a fluidic connection coupling (44) between the line coupler and the spraying device connector, and the retaining device in a second state is configured to prevent non-destructive detachment of the fluidic connector coupling.

### BACKGROUND

The present invention relates to a windshield wiper for a vehicle.

Spraying devices are currently used in conjunction with windshield wipers to clean vehicle surfaces. By means of the spraying devices, a cleaning fluid is applied to the surface, and the windshield wiper removes the cleaning fluid and dirt from the surface. The spraying devices are in this case installed separately from the windshield wiper in the vehicle. In order to clean a windshield, the spraying device is, e.g., located in the form of hood nozzles in the immediate vicinity of the hood, whereas the windshield wiper is arranged on a surface of the windshield.

In alternative concepts, the spraying device is arranged on the wiper blade. A fluid line must in this case be routed from a supply tank, along a wiper arm of the windshield wiper, and into the spraying device of the windshield wiper blade. Given that the windshield wiper blade wears with use, the windshield wiper blade is mounted separately from the windshield wiper arm. As a result, a plug-in connection is provided at the transition between the wiper arm and the wiper blade for a fluidic connection between the supply tank and the spraying device. The plug-in connection is designed such that it can be overcome by an ordinary user in order to separate and join the plug-in connection. Such a windshield wiper system is disclosed in document EP 3 124 336 A1.

### SUMMARY

The windshield wiper system for a vehicle according to the invention comprises a wiper blade having a spraying device, a fluid line, a wiper arm on which the fluid line is arranged or retained, and a retaining device. The spraying device comprises a spraying device connector. The fluid line comprises a line coupler. The fluid line and the spraying device can be fluidically connected to each other via the line coupler and the spraying device connector in a non-destructive and detachable manner. The retaining device is arranged on the wiper blade. In a first state, the retaining device is configured to enable non-destructive detachment of a fluidic connector coupling between the line coupler and the spraying device connector. In a second state, the retaining device is designed to prevent non-destructive detachment of the fluidic connector coupling.

At temperatures around freezing point and below, the cleaning fluid in the spraying device and at the outlets of the spraying device can sometimes freeze. This reduces the discharge of the cleaning fluid and increases the pressure of the cleaning fluid in the spraying device, the fluid line, and the connector coupling. If the connector coupling is designed as a plug-in connection, then the increase in pressure of the cleaning fluid as a result of the cleaning fluid freezing in the spraying device can overcome a retaining force of the plug-in connection and detach the plug-in connection. The cleaning fluid escapes at the connector coupling instead of the outlets of the spraying device. The retaining device prevents non-destructive detachment of the fluidic connector coupling in a second state. As a result, the retaining device can prevent the connector coupling from detachment, even if the cleaning fluid in the spraying device is partially frozen. The same applies to other causes of the increase in pressure of the cleaning fluid in the connector coupling. Given that a non-destructive detachment of the connector coupling is possible in the first state of the retaining device, it is also possible for a user to separate the wiper blade from the wiper arm without special tools. As a result, the windshield wiper is easy for the user to handle, and unintentional detachment of the connector coupling is prevented.

The retaining device is preferably arranged on the wiper blade in a rotatable manner. The first state corresponds to a first position of the retaining device, and the second state corresponds to a second position of the retaining device. The rotatability of the retaining device relative to the wiper blade enables a straightforward transition of the retaining device from the first state of the retaining device into the second state of the retaining device, and vice versa. As a result, the operation and the state change of the retaining device are simplified, thereby preventing the connector coupling achieved by the retaining device from unintentionally being detached by the user.

The retaining device preferably comprises at least one, in particular multiple, latches. In a first position of the retaining device, the latch is designed to enable a pull-off movement of the line coupler from the spraying device connector in order to detach the fluidic connector coupling along a pull-off direction. The latch is also designed to prevent a pull-off movement of the line coupler from the spraying device connector in order to detach the fluidic connector coupling along the pull-off direction in a second position of the retaining device. A latch enables large forces to be dissipated, and is in this case space-saving and easy to manufacture. The latch is also a simple mechanism that requires no additional components. Given the simplicity of the latch mechanism, the proper use of the latch can be directly checked by the user.

The latch is preferably designed to be integral with the retaining device. As a result, the geometric complexity of the retaining device is not significantly increased, thus eliminating the need for further manufacturing steps during the separate production of the latch and a mechanical connection of the latch to the retaining device. Overall, the integral design of the retaining device with the latch reduces the manufacturing costs of the windshield wiper.

Advantageously, the latch is arranged to engage into at least one recess of the retaining device in the second position of the retaining device. A plurality of latches and recesses is preferably provided, whereby each latch preferably engages into its own recess. This increases reliability and enables greater forces to be dissipated via the large number of recesses.

In the second position of the retaining device, the latch is particularly advantageously arranged at an end of the line coupler opposite the fluidic connector coupling in order to prevent detachment of the fluidic connector coupling by a pull-off movement of the line coupler in a pull-off direction. As a result, no recesses are required for engaging the latch into the connector coupling. The manufacturing complexity of the connector coupling is reduced as a result.

Advantageously, the wiper arm is mechanically connected to the wiper blade by means of the retaining device. As a result, no additional element is required for the mechanical connection between the wiper arm and the wiper blade. This reduces the space required for the windshield wiper, as well as the manufacturing complexity and manufacturing costs of the windshield wiper.

One particularly advantageous feature is that the wiper arm is mechanically connected to the retaining device in a non-rotatable manner. As a result, the wiper arm does not rotate relative to the retaining device. This ensures that a rotation of the retaining device relative to the wiper blade also results in a rotation of the wiper arm relative to the wiper blade. The first position of the retaining device is a rotation in a first angular range of the wiper blade relative to the wiper arm, and the second position of the retaining device is a rotation in a second angular range of the wiper blade relative to the wiper arm. The transition from the first state to the second state is therefore possible by simply turning the wiper arm, and thus the retaining device to the wiper blade. This makes it easier for the user to fit and remove the wiper blade and thus change the wiper blade altogether.

Preferably, the second position of the retaining device comprises at least an angular range of 0° to 5° in relation to the pull-off direction. This angular range of 0° to 5° represents the usual angular range between a wiper arm and a wiper blade when the wiper blade is in contact with a surface of the vehicle. Therefore, the retaining device is located on the surface during normal contact of the windshield wiper in the second state, whereby the retaining device prevents non-destructive detachment of the connector coupling during normal contact of the windshield wiper with the surface. The first position preferably comprises an angular range above 5° between the wiper arm and the wiper blade. As a result, the connector coupling can be detached in a non-destructive manner in an angular range greater than 5°. This selection of the first position and the second position prevents non-destructive detachment of the connector coupling during normal contact and wiping of the wiper blade, and also enables simple non-destructive detachment of the connector coupling via twisting into the angular range above 5° between the wiper arm and the wiper blade.

Particularly preferably, the second position of the retaining device corresponds to an operating position in which the wiper blade can be placed against a surface being cleaned. As a result, the retaining device is located on the surface in the second state during normal contact of the windshield wiper, whereby the retaining device prevents non-destructive detachment of the connector coupling during normal contact of the windshield wiper with the surface. The first position of the retaining device preferably corresponds to an angular range outside the operating position of the wiper blade. This selection of the first position and the second position prevents non-destructive detachment of the connector coupling during normal contact and wiping of the wiper blade in an operating position, and also enables simple non-destructive detachment of the connector coupling by rotating the wiper arm into the angular range outside the operating position of the wiper blade.

Advantageously, the retaining device can be mechanically connected to the wiper arm in the first state in a non-destructive and detachable manner. In the first state, the connector coupling can therefore be detached, and the wiper blade can be removed from the wiper arm at the same time. As a result, it is possible to detach the connector coupling (and the wiper blade from the wiper arm) in one step. It is also possible to connect the wiper blade to the wiper arm and provide the connector coupling in one step. Consequently, the non-destructive mechanical detachment of the wiper blade from the wiper arm makes it easier to fit and remove the wiper blade.

Particularly advantageously, in the second state of the retaining device, the latter is configured to prevent a non-destructive detachment of the mechanical connection to the wiper arm. Therefore, the connector coupling and the second mechanical connection between the wiper arm and the wiper blade are simultaneously prevented from detaching in the second state of the retaining device.

Preferably, the line connector and the spraying device connector can be mechanically connected to each other via a snap connection. The snap connection ensures that the line coupler and the spraying device connector are not inadvertently detached when the retaining device is in the first state. In addition, the snap connection has the advantage that, after connecting the line coupler to the spraying device connector, this connection does not loosen when the retaining device is transferred from a first state to a second state of the retaining device. This enables easy handling of the windshield wiper and easy replacement of the windshield wiper blade.

Particularly preferably, the line coupler and/or the spraying device connector comprise(s) at least one seal, so that no cleaning fluid escapes at a predefined fluid pressure in the connector coupling. The result is a reduction in the loss of cleaning fluid while the spraying device is being supplied with cleaning fluid.

### BRIEF DESCRIPTION OF THE DRAWINGS

Exemplary embodiments of the invention are described in detail hereinafter with reference to the accompanying drawings. The drawings show:

FIG. 1 a schematic representation of a vehicle with a windshield wiper according to one embodiment of the invention,

FIG. 2 a schematic representation of elements of the windshield wiper according to the embodiment of the invention, and

FIG. 3 a schematic representation of the retaining element and the connector coupling according to the exemplary embodiment of the invention.

### DETAILED DESCRIPTION

FIG. 1 shows a schematic representation of a vehicle 1 with a windshield wiper 2 according to one embodiment of the invention. The windshield wiper 2 is arranged on the windshield 5 and is designed to clean the windshield 5.

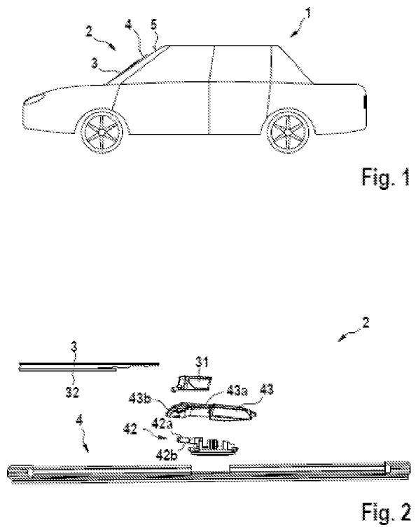

FIG. 2 shows a schematic representation of elements of the windshield wiper 2 according to the embodiment of the invention.

The windshield wiper 2 comprises a wiper blade 4 with a spraying device 41, a fluid line 32, a wiper arm 3 on which the fluid line 32 is arranged or retained, and a retaining device 43. The spraying device 41 comprises a spraying device connector 42. The fluid line 32 comprises a line coupler 31. The fluid line 32 and the spraying device 41 can be connected to each other in a non-destructive and detachable fluidic connection via the line coupler 31 and the spraying device connector 42. The retaining device 43 is arranged on the wiper blade 4. In a first state, the retaining device 43 is designed to enable non-destructive detachment of a fluidic connector coupling 44 between the line coupler 31 and the spraying device connector 42. The retaining device 43 is also designed to prevent non-destructive detachment of the fluidic connector coupling 44 in a second state.

At temperatures around freezing point and below, a cleaning fluid may partially freeze in the spraying device 41 and at outlets of the spraying device 41. This reduces an outlet of the cleaning fluid and increases the pressure of the cleaning fluid in the spraying device 41, the fluid line 32, and the connector coupling 44. If the connector coupling 44 is designed as a plug-in connection, then the increase in pressure of the cleaning fluid as a result of the freezing of the cleaning fluid in the spraying device 41 can overcome a retaining force of the plug-in connection and detach the plug-in connection. The cleaning fluid emerges at the connector coupling 44 instead of the outlets of the spraying device 41. The retaining device 43 prevents non-destructive detachment of the fluidic connector coupling 44 in a second state. Therefore, the retaining device 43 is able to prevent the connector coupling 44 from detaching, even if the cleaning fluid in the spraying device 41 is partially frozen. The same applies to other causes of the increase in pressure of the cleaning fluid in the connector coupling 44. Given that non-destructive detachment of the connector coupling 44 is enabled in the first state of the retaining device 43, it is also possible for a user to separate the wiper blade 4 from the wiper arm 3 without special tools. As a result, easy usage of the windshield wiper 2 by the user is enabled, and unintentional detachment of the connector coupling 44 is prevented.

The retaining device 43 is rotatably arranged on the wiper blade 4 and the wiper arm 3 is mechanically connected to the retaining device 43 in such a way that it cannot rotate. As a result, the wiper arm 3 does not rotate relative to the retaining device 43. The first state corresponds to a first position of the retaining device 43, and the second state corresponds to a second position of the retaining device 43. The rotatability of the retaining device 43, and thus of the wiper arm 3 relative to the wiper blade 4, enables an easy transition of the retaining device 43 from the first state of the retaining device 43 into the second state of the retaining device 43, and vice versa, by rotating the wiper arm 3 relative to the wiper blade 4. This facilitates user operation and changing the state of the retaining device 43 and, therefore, the reliability of the connector coupling 44 achieved by the retaining device 43 against unintentional detachment of the connector coupling 44 by the user.

In the first state, the retaining device 43 can be mechanically connected to the wiper arm 3 in a non-destructive and detachable manner. In the second state of the retaining device 43, non-destructive detachment of the mechanical connection between the wiper arm and the retaining device 43 is prevented. For the connection between the wiper arm 3 and the retaining device 43, a section of the wiper arm 3 is accommodated in a recess 43b of the retaining device 43. In the first state of the retaining device 43, the connector coupling 44 can therefore be detached at the same time, and the wiper blade 4 can be removed from the retaining device 43, and thus from the wiper arm 3. In the second state of the retaining device 43, both the connector coupling 44 and the mechanical connection between the wiper arm 3 and the wiper blade 4 are likewise prevented from detachment. Given that the connector coupling 44 and the mechanical connection between the wiper blade 4 and the wiper arm 3 can be made in the same state, the wiper blade 4 can be detached in one step. Consequently, the non-destructive mechanical detachment of the wiper blade 4 from the wiper arm 3 makes it easier to fit and remove the wiper blade 4.

The retaining device 43 comprises a latch 43a, and the retaining device 43 is designed to be integral with the latch 43a. In a first position of the retaining device 43, the latch 43a is designed to enable a pull-off movement of the line coupler 31 from the spraying device connector 42 in order to detach the fluidic connector coupling 44 along a pull-off direction 100. In a second position of the retaining device 43, the latch 43a is designed to prevent a pull-off movement of the line coupler 31 from the spraying device connector 42 in order to detach the fluidic connector coupling 44 along a pull-off direction 100.

The fluidic coupler comprises a recess, into which the latch 43a can be inserted via rotation of the retaining device 43, thus transitioning the retaining device 43 from the first state to the second state. In this context, the dimensions of the latch 43a are adapted to the forces expected given an increase in pressure as a result of at least partial freezing of the cleaning agent in the spraying device 41.

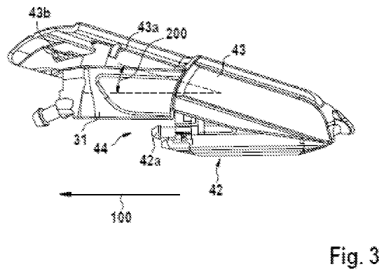

In an alternative embodiment, the latch 43a is, in the second position of the retaining device 43, arranged at an end of the line coupler 31 opposite the fluidic connector coupling 44 in order to prevent a pull-off movement of the line coupler 31 from detaching the fluidic connector coupling 44 in a pull-off direction 100. This point is located at the upper left end of the line coupler 31. As seen in FIG. 3, this point is not further concealed and is therefore easily visible to a user. The user can immediately recognize whether the latch 43a will prevent the pull-off movement of the fluidic coupler. In addition, this alternative design of the retaining device 43 can also omit a recess for engaging the latch 43a into the connector coupling 44. As a result, the manufacturing complexity of the connection 44 is reduced.

The second position of the retaining device 43 comprises at least an angular range 200 of 0° to 5° in relation to the pull-off direction 100. This angular range 200 of 0° to 5° represents the usual angular range 200 between a wiper arm 3 and a wiper blade 4 when the wiper blade 4 is in contact with a surface of the vehicle 1. Therefore, the retaining device 43 in the second state is located on the surface during normal contact of the windshield wiper 2, whereby the retaining device 43 prevents non-destructive detachment of the connector coupling 44 during normal contact of the windshield wiper 2 with the surface. The first position comprises an angular range 200 above 5° between the wiper arm 3 and the wiper blade 4. As a result, it is possible to detach the connector coupling 44 in a non-destructive manner in an angular range 200 greater than 5°. This selection of the first position and the second position prevents non-destructive detachment of the connector coupling 44 during normal contact and wiping of the wiper blade 4, and also enables straightforward and non-destructive detachment of the connector coupling 44 by rotation into the angular range 200 above 5° between the wiper arm 3 and the wiper blade 4.

The line coupler 31 and the spraying device connector 42 can be mechanically connected to each other via a snap connection 42a. The snap connection 42a ensures that the line coupler 31 and the spraying device connector 42 do not inadvertently detach when the retaining device 43 is in the first state. The snap connection 42a offers the further advantage that, after connecting the line coupler 31 to the spraying device connector 42, this connection does not loosen when the retaining device 43 is transferred from a first state to a second state of the retaining device 43. This enables easy handling of the windshield wiper 2 and easy replacement of the wiper blade 4.

The spraying device connector 42 comprises a seal 42b, so that no cleaning fluid escapes at a predefined fluid pressure in the connector coupling 44. The result is reducing the loss of cleaning fluid during a supply of cleaning fluid to the spraying device 41. Amendments to the Claims

1. A windshield wiper system (2) for a vehicle (1), comprising
a wiper blade (4) having a spraying device (41),
a fluid line (32),
a wiper arm (3) on which the fluid line (32) is arranged or retained, and
a retaining device (43),
wherein the spraying device (41) comprises a spraying device connector (42),
wherein the fluid line (32) comprises a line coupler (31),
wherein the fluid line (32) and the spraying device (41) can be connected to each other in a non-destructive and detachable fluidic connection via the line coupler (31) and the spraying device connector (42),
wherein the retaining device (43) is arranged on the wiper blade (4),
wherein the retaining device (43) in a first state is configured to enable non-destructive detachment of a fluidic connection (44) between the line coupler (31) and the spraying device connector (42), and
wherein the retaining device (43) in a second state is configured to prevent non-destructive detachment of the fluidic connection coupling (44).

2. The windshield wiper system (2) according to claim 1, wherein the retaining device (43) is rotatably arranged on the wiper blade (4), the first state corresponds to a first position of the retaining device (43), and the second state corresponds to a second position of the retaining device (43).

3. The windshield wiper system (2) according to claim 2, wherein the retaining device (43) comprises at least one latch (43a),
wherein the latch (43a) is, in a first position of the retaining device (43), configured to enable a pull-off movement of the line coupler (31) from the spraying device connector (42) in order to detach the fluidic connection coupling (44) along a pull-off direction (100), and
wherein the latch (43a) is, in a second position of the retaining device (43), configured to prevent the pull-off movement of the line coupler (31) from the spraying device connector (42).

4. The windshield wiper system (2) according to claim 3, wherein the latch (43a) is configured to engage into at least one recess of the retaining device (43) in the second position of the retaining device (43).

5. The windshield wiper system (2) according to claim 3, wherein, in the second position of the retaining device (43), the latch (43a) is arranged at an end of the line coupler (31) opposite the fluidic connection coupling (44) in order to prevent the pull-off movement of the line coupler (31) along the pull-off direction (100) from detaching the fluidic connector coupling (44).

6. The windshield wiper system (2) according to claim 1. wherein the wiper arm (3) is mechanically connected to the wiper blade (4) by the retaining device (43).

7. The windshield wiper system (2) according to claim 2, wherein the second position of the retaining device (43) comprises at least an angular range (200) of 0° to 5° with respect to a pull-off direction (100).

8. The windshield wiper system (2) according to claim 2, wherein the second position of the retaining device (43) corresponds to an operating position in which the wiper blade (4) can be placed against a surface being cleaned.

9. The windshield wiper system (2) according to claim 1, wherein the retaining device (43) can be mechanically connected to the wiper arm (3) in the first state in a non-destructive and detachable manner.

10. The windshield wiper system (2) according to claim 1, wherein the retaining device (43) in the second state is configured to prevent non-destructive detachment of a mechanical connection to the wiper arm (3).

11. The windshield wiper system (2) according to claim 1, wherein the line coupler (31) and the spraying device connector (42) can be mechanically connected to one another via a snap connection (42a).

12. The windshield wiper system (2) according to claim 4, wherein, in the second position of the retaining device (43), the latch (43a) is arranged at an end of the line coupler (31) opposite the fluidic connection coupling (44) in order to prevent the pull-off movement of the line coupler (31) along the pull-off direction (100) from detaching the fluidic connector coupling (44).
